(19) United States
(12) Patent Application Publication
(10) Pub. No.: US 2026/0126407 A1
(43) Pub. Date: May 7, 2026

(54) APPARATUS AND METHOD FOR DETECTING MOISTURE

(71) Applicant: HL MANDO CORPORATION, Pyeongtaek-si (KR)

(72) Inventor: Hanjun LEE, Pyeongtaek-si (KR)

(73) Assignee: HL MANDO CORPORATION, Pyeongtaek-si (KR)

(21) Appl. No.: 19/380,540

(22) Filed: Nov. 5, 2025

(30) Foreign Application Priority Data
Mar. 20, 2025 (KR) 10-2025-0036150
Nov. 5, 2024 (KR) 10-2024-0155700

(51) Int. Cl. G01N 27/04; B60T 17/22

(52) U.S. Cl. CPC G01N 27/048; B60T 17/22

(57) ABSTRACT

The present disclosure relates to an apparatus and method for detecting moisture in brake fluid of vehicle brake systems. A moisture detection apparatus comprises a moisture detection module configured to output a signal based on moisture content of brake fluid stored in a reservoir, and a controller configured to identify the moisture content of the pressurized medium based on the output signal. The moisture detection module comprises a substrate, a plurality of electrode patterns provided on the substrate and configured to be submerged in the brake fluid, a connector provided on the reservoir and connected to the controller, and a signal line connecting the electrode patterns and the connector. The controller generates a monitoring signal based on output signals from the electrode patterns, compares the monitoring signal with preset reference data, and identifies the moisture content based on the comparison result.

### CROSS REFERENCE TO PARENT APPLICATIONS

Pursuant to 35 U.S.C. § 119(a), this application claims the benefit of earlier filing date and right of priority to Korean Patent Application Nos. 10-2024-0155700, filed on November 5, 2024, and 10-2025-0036150, filed on March 20, 2025, the contents of which are all hereby incorporated by reference herein in their entireties.

### BACKGROUND

A braking system is one of the most important elements in a vehicle and is directly related to the life of a driver, so robust design to prevent failures is essential.

Recently, electronic brake systems with backup functions have been developed by applying redundancy circuit design, but there is still a disadvantage in that risks such as vapor lock persist because the power source remains a hydraulic system.

Vapor lock is a phenomenon in which the braking force drops sharply because normal pressure cannot be formed during braking due to bubble generation in the brake oil, and is one of the typical defects of brakes. The fundamental cause of this phenomenon is that when moisture enters the oil, the boiling point is lowered and it is easily vaporized under high temperature conditions.

Generally, when the moisture content exceeds three percent, it is recommended to replace the entire oil. However, a method for self-diagnosing the quality of oil in a vehicle is not currently applied, and as a result, the driver must continuously perform preventive maintenance to prevent brake failure due to vapor lock.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, An apparatus for detecting moisture, comprises a moisture detection module configured to output a signal based on moisture content of a pressurized medium stored in a reservoir, and a controller configured to identify the moisture content of the pressurized medium based on an output signal of the moisture detection module, wherein the moisture detection module comprises a substrate, a plurality of electrode patterns provided on the substrate and configured to be submerged in the pressurized medium, a connector provided on one side of the reservoir and connected to the controller, and a signal line connecting the plurality of electrode patterns and the connector, wherein the controller is configured to generate a monitoring signal based on an output signal of at least one of the plurality of electrode patterns, compare the monitoring signal with preset reference data, and identify the moisture content of the pressurized medium based on a comparison result.

The reference data may include at least one of a reference voltage level, a reference current level, and a reference matching resistance value between the plurality of electrode patterns corresponding to the moisture content of the pressurized medium.

The controller may include a memory storing a lookup table in which the reference data is recorded.

The plurality of electrode patterns may include a first electrode pattern provided on at least one surface of the substrate and to which a reference voltage is applied, and a second electrode pattern provided on at least one surface of the substrate spaced apart from the first electrode pattern and configured to output a signal based on the moisture content of the pressurized medium.

The plurality of electrode patterns may further include a third electrode pattern provided on another surface of the substrate and to which the reference voltage is applied, and a fourth electrode pattern provided on the other surface of the substrate and configured to output a signal based on the moisture content of the pressurized medium.

The controller may generate the monitoring signal based on a signal output from the second electrode pattern by a resistance formed between the first electrode pattern and the second electrode pattern.

The plurality of electrode patterns may include a first electrode pattern provided on one surface of the substrate and to which a reference voltage is applied, and a second electrode pattern provided on another surface of the substrate and configured to output a signal based on the moisture content of the pressurized medium.

The connector may be integrally provided on a reservoir cap coupled to an upper end of the reservoir.

Each of the plurality of electrode patterns may extend linearly along one axial direction of the substrate, and the substrate may be vertically arranged based on connection of the connector and the signal line.

The moisture detection module may output a signal based on a change in level of the pressurized medium.

The controller may output a warning signal when the moisture content of the pressurized medium exceeds a preset threshold value.

According to some embodiments of the present disclosure, a method for detecting moisture content of a pressurized medium by a moisture detection apparatus comprises applying a reference voltage to at least one of a plurality of electrode patterns, monitoring an electrical characteristic between an electrode pattern to which the reference voltage is applied and an electrode pattern corresponding to the electrode pattern to which the reference voltage is applied, generating a monitoring signal based on the monitored electrical characteristic, comparing the monitoring signal with preset reference data, and identifying the moisture content of the pressurized medium based on a comparison result.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 illustrates a configuration of an electronic brake system and a vehicle related thereto according to one or more exemplary embodiments of the present disclosure.

FIG. 2 illustrates a circuit configuration of an electronic brake system according to one or more exemplary embodiments of the present disclosure.

FIG. 3 illustrates a schematic configuration of a moisture detection apparatus according to one or more exemplary embodiments of the present disclosure.

FIG. 4 illustrates an installation structure of a moisture detection apparatus according to one or more exemplary embodiments of the present disclosure.

FIG. 5 illustrates in detail a configuration of a moisture detection module according to one or more exemplary embodiments of the present disclosure.

FIG. 6 illustrates a circuit configuration of a moisture detection apparatus according to one or more exemplary embodiments of the present disclosure.

FIGS. 7 and 8 illustrate output signals of a moisture detection module according to types of pressurized medium.

FIG. 9 illustrates electrode patterns of a moisture detection module according to another exemplary embodiments of the present disclosure.

FIG. 10 illustrates electrode patterns of a moisture detection module according to still another exemplary embodiments of the present disclosure.

FIG. 11 illustrates a moisture detection method according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the disclosure may be implemented. These embodiments are described in sufficient detail to enable those skilled in the art to implement the disclosure, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

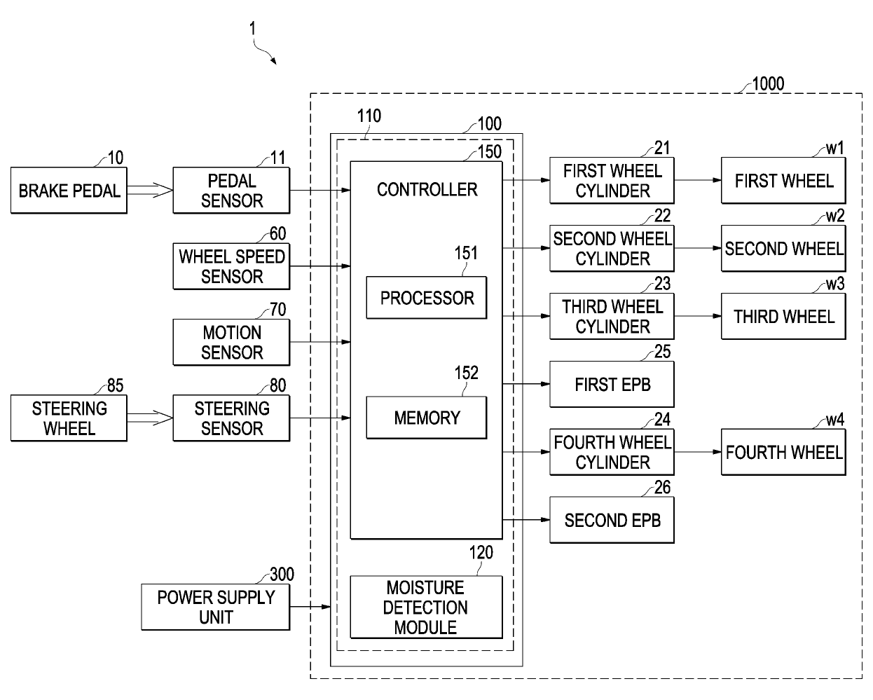

Referring to FIG. 1, a vehicle 1 may include a plurality of wheels w1, w2, w3, w4 that rotate.

Each of the plurality of wheels w1, w2, w3, w4 may include, for example, a first wheel w1 provided on a front left FL of the vehicle 1, a second wheel w2 provided on a front right FR of the vehicle 1, a third wheel w3 provided on a rear left RL of the vehicle 1, and/or a fourth wheel w4 provided on a rear right RR of the vehicle 1. However, the number of wheels w1, w2, w3, w4 is not limited to four.

As shown in FIG. 1, the vehicle 1 may include a brake pedal 10 that obtains a driver's input regarding braking, a pedal sensor 11 that detects movement of the brake pedal 10, a wheel speed sensor 60 that detects rotational speeds of each wheel w1, w2, w3, w4, a steering wheel 85 that obtains a driver's input regarding steering, a motion sensor 70 that detects movement of the vehicle 1, a steering sensor 80 that detects rotation of the steering wheel 85, a gear position sensor 92 that detects a gear position of the vehicle 1, an ignition detection sensor 94 that detects an ignition state of the vehicle 1, and an electronic brake system 1000 that provides braking force to the plurality of wheels w1, w2, w3, w4 to stop the vehicle 1. The electronic brake system 1000 provides the operational environment for the moisture detection apparatus of the present disclosure. The moisture detection apparatus monitors the condition of the pressurized medium such as brake oil within the electronic brake system 1000 to ensure reliable brake operation by detecting moisture content that could lead to vapor lock or other hydraulic system failures.

Here, the pedal sensor 11, wheel speed sensor 60, motion sensor 70, steering sensor 80, gear position sensor 92, and ignition detection sensor 94 are not essential components, and all or at least some of them may be omitted.

The electronic brake system 1000 may include a first wheel cylinder 21 and a second wheel cylinder 22 provided on left and right wheels of a first axle of the vehicle 1, respectively, a third wheel cylinder 23 and a fourth wheel cylinder 24 provided on left and right wheels of a second axle of the vehicle 1, respectively, and a brake module 100 that sets a target braking pressure based on an output signal of the pedal sensor 11 and provides hydraulic pressure to the plurality of wheel cylinders 21, 22, 23, 24 based on the target braking pressure.

Here, the first axle of the vehicle 1 may be set as front wheels, and the second axle of the vehicle 1 may be set as rear wheels. However, it is not limited thereto, and according to design, the first axle may be set as rear wheels and the second axle may be set as front wheels.

The plurality of wheel cylinders 21, 22, 23, 24 may brake each wheel w1, w2, w3, w4 to brake the vehicle 1. For example, the first wheel cylinder 21 brakes the first wheel w1, the second wheel cylinder 22 brakes the second wheel w2, the third wheel cylinder 23 brakes the third wheel w3, and the fourth wheel cylinder 24 may brake the fourth wheel w4.

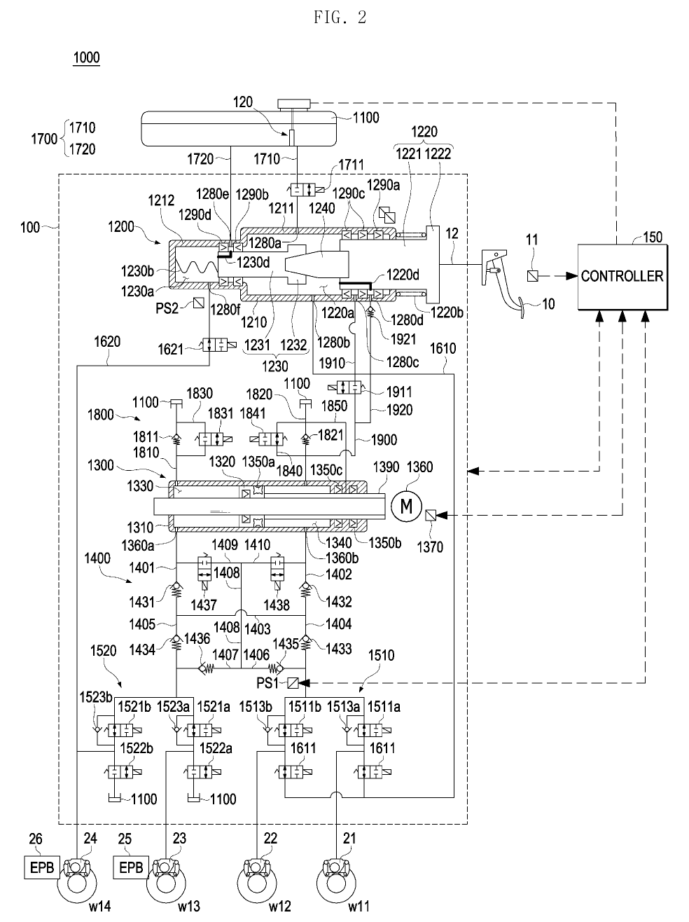

Referring to FIG. 2, the brake module 100 may include a reservoir 1100 in which a pressurized medium is stored, an integrated master cylinder 1200 that provides reaction force according to pedal force of the brake pedal 10 to the driver and pressurizes and discharges a pressurized medium such as brake oil accommodated inside, a hydraulic pressure supply device 1300 that receives a driver's braking intention as an electrical signal from the pedal sensor 11 that detects displacement of the brake pedal 10 and generates hydraulic pressure of the pressurized medium through mechanical operation, a hydraulic control unit 1400 that controls hydraulic pressure provided from the hydraulic pressure supply device 1300, hydraulic circuits 1510, 1520 having wheel cylinders 21, 22, 23, 24 to which hydraulic pressure of the pressurized medium is transmitted to perform braking of each wheel RR, RL, FR, FL, backup flow paths 1610, 1620 that hydraulically connect the integrated master cylinder 1200 and the hydraulic circuits 1510, 1520, reservoir flow paths 1710, 1720 that hydraulically connect the reservoir 1100 and the integrated master cylinder 1200, a dump control unit 1800 provided between the hydraulic pressure supply device 1300 and the reservoir 1100 to control flow of the pressurized medium, an inspection flow path 1900 provided to connect the integrated master cylinder 1200 and the hydraulic pressure supply device 1300 to inspect whether various component elements leak, and a controller ECU 150 that controls the hydraulic pressure supply device 1300 and various valves based on hydraulic pressure information and pedal displacement information.

The integrated master cylinder 1200 may be provided to provide reaction force to the driver for a stable pedal feel when the driver applies pedal force to the brake pedal 10 for braking operation, and pressurize and discharge the pressurized medium accommodated inside by operation of the brake pedal 10.

In the integrated master cylinder 1200, a master cylinder that pressurizes and discharges the pressurized medium accommodated inside by pedal force of the brake pedal 10 and a pedal simulator 1240 that provides a pedal feel to the driver may be arranged coaxially in one cylinder body 1210.

The integrated master cylinder 1200 may include a cylinder body 1210 forming a chamber inside, a first master chamber 1220a formed on an inlet side of the cylinder body 1210 to which the brake pedal 10 is connected, a first master piston 1220 provided in the first master chamber 1220a and connected to the brake pedal 10 to be displaceably provided by operation of the brake pedal 10, a second master chamber 1230a formed inside or forward (left side based on FIG. 2) than the first master chamber 1220a on the cylinder body 1210, a second master piston 1230 provided in the second master chamber 1230a and displaceably provided by displacement of the first master piston 1220 or hydraulic pressure of the pressurized medium accommodated in the first master chamber 1220a, and a pedal simulator 1240 disposed between the first master piston 1220 and the second master piston 1230 to provide a pedal feel through elastic restoring force generated during compression.

The first master chamber 1220a and the second master chamber 1230a may be sequentially formed from the brake pedal 10 side (right side based on FIG. 2) to the inside (left side based on FIG. 2) on the cylinder body 1210 of the integrated master cylinder 1200. In addition, the first master piston 1220 and the second master piston 1230 may be provided in the first master chamber 1220a and the second master chamber 1230a, respectively, to form hydraulic pressure or negative pressure in the pressurized medium accommodated in each chamber according to forward and backward movement.

The cylinder body 1210 may include a large diameter portion 1211 in which the first master chamber 1220a is formed inside and the inner diameter is formed relatively large, and a small diameter portion 1212 in which the second master chamber 1230a is formed inside and the inner diameter is formed relatively smaller than the large diameter portion 1211. The large diameter portion 1211 and the small diameter portion 1212 of the cylinder body 1210 may be integrally formed.

The first master chamber 1220a may be formed inside the large diameter portion 1211 which is an inlet side or rear side (right side based on FIG. 2) of the cylinder body 1210, and in the first master chamber 1220a, a first master piston 1220 connected to the brake pedal 10 through an input rod 12 may be accommodated to be reciprocally movable.

The first master chamber 1220a may have a pressurized medium flow in and out through a first hydraulic port 1280a, a second hydraulic port 1280b, a third hydraulic port 1280c, and a fourth hydraulic port 1280d. The first hydraulic port 1280a is connected to a first reservoir flow path 1710 to be described later, so that the pressurized medium may flow from the reservoir 1100 to the first master chamber 1220a or the pressurized medium accommodated in the first master chamber 1220a may be discharged to the reservoir 1100. The second hydraulic port 1280b is connected to a first backup flow path 1610 to be described later, so that the pressurized medium may be discharged from the first master chamber 1220a to the first backup flow path 1610 side or conversely the pressurized medium may flow from the first backup flow path 1610 to the first master chamber 1220a side.

In addition, the first master chamber 1220a may be connected to a first branch flow path 1910 and a second branch flow path 1920 of an inspection flow path 1900 to be described later through the third hydraulic port 1280c and the fourth hydraulic port 1280d, respectively, so that the pressurized medium accommodated in the first master chamber 1220a may be discharged to the inspection flow path 1900 side or the pressurized medium may flow from the inspection flow path 1900 to the first master chamber 1220a. A detailed description thereof will be given later.

The first master piston 1220 may be accommodated in the first master chamber 1220a to form hydraulic pressure by pressurizing the pressurized medium accommodated in the first master chamber 1220a by moving forward (left direction based on FIG. 2), or form negative pressure inside the first master chamber 1220a by moving backward (right direction based on FIG. 2). The first master piston 1220 may include a first body 1221 formed in a cylindrical shape to be in close contact with an inner circumferential surface of the first master chamber 1220a, and a first flange 1222 expanded in a radial direction at a rear end (right end based on FIG. 2) of the first body 1221 and to which the input rod 12 is connected. The first master piston 1220 may be elastically supported by a first piston spring 1220b, and one end of the first piston spring 1220b is supported on a front surface (left surface based on FIG. 2) of the first flange 1222 and the other end is supported on an outer surface of the cylinder body 1210.

The first master piston 1220 may be provided with a first cut-off hole 1220d that communicates with the first master chamber 1220a and simultaneously communicates with the fourth hydraulic port 1280d and the second branch flow path 1920 in a non-operating state, that is, in a ready state before displacement occurs. In addition, between an outer circumferential surface of the first master piston 1220 and the cylinder body 1210, a first sealing member 1290a that seals the first master chamber 1220a from the outside may be provided. The first sealing member 1290a may be provided to be seated in a receiving groove formed recessed on an inner circumferential surface of the cylinder body 1210 to be in contact with an outer circumferential surface of the first master piston 1220, and the first sealing member 1290a may prevent the pressurized medium accommodated in the first master chamber 1220a from leaking to the outside and simultaneously prevent foreign substances from flowing into the first master chamber 1220a. The first sealing member 1290a may be provided on an outermost side on an inner circumferential surface of the cylinder body 1210, that is, on a rear side (right side based on FIG. 2) of the fourth hydraulic port 1280d to which the second branch flow path 1920 to be described later is connected.

Between an outer circumferential surface of the first master piston 1220 and the cylinder body 1210, a third sealing member 1290c that blocks flow of the pressurized medium flowing from the first branch flow path 1910 connected to the third hydraulic port 1280c to the first master chamber 1220a may be provided. The third sealing member 1290c may be seated in a pair of receiving grooves formed recessed on the front and rear of the third hydraulic port 1280c on an inner circumferential surface of the cylinder body 1210, respectively, to be in contact with an outer circumferential surface of the first master piston 1220. The pair of third sealing members 1290c may be provided in front (left side based on FIG. 2) of the first sealing member 1290a, and may allow flow of the pressurized medium accommodated in the first master chamber 1220a to be transmitted to the first branch flow path 1910 through the third hydraulic port 1280c, but block flow of the pressurized medium flowing from the first branch flow path 1910 to the first master chamber 1220a.

The second master chamber 1230a may be formed inside the small diameter portion 1212 which is an inside or forward side (left side based on FIG. 2) on the cylinder body 1210, and in the second master chamber 1230a, a second master piston 1230 may be accommodated to be reciprocally movable.

The second master chamber 1230a may have a pressurized medium flow in and out through a fifth hydraulic port 1280e and a sixth hydraulic port 1280f. The fifth hydraulic port 1280e is connected to a second reservoir flow path 1720 to be described later, so that the pressurized medium accommodated in the reservoir 1100 may flow to the second master chamber 1230a side. In addition, the sixth hydraulic port 1280d is connected to a second backup flow path 1620 to be described later, so that the pressurized medium accommodated in the second master chamber 1230a may be discharged to the second backup flow path 1620 side or conversely the pressurized medium may flow from the second backup flow path 1620 to the second master chamber 1230a side.

The second master piston 1230 may be accommodated in the second master chamber 1230a to form hydraulic pressure of the pressurized medium accommodated in the second master chamber 1230a by moving forward or form negative pressure in the second master chamber 1230a by moving backward. The second master piston 1230 may include a second body 1231 formed in a cylindrical shape to be in close contact with an inner circumferential surface of the second master chamber 1230a, and a second flange 1232 expanded in a radial direction at a rear end (right end based on FIG. 2) of the second body 1231 and disposed inside the first master chamber 1220a. A diameter of the second flange 1232 may be formed larger than an inner circumferential surface diameter of the second master chamber 1230a. The second master piston 1230 may be elastically supported by a second piston spring 1230b, and one end of the second piston spring 1230b is supported on a front surface (left surface based on FIG. 2) of the second body 1231 and the other end may be supported on an inner surface of the cylinder body 1210.

Between an outer circumferential surface of the second master piston 1230 and the cylinder body 1210, a second sealing member 1290b that seals the first master chamber 1220a with respect to the second master chamber 1230a may be provided. The second sealing member 1290b may be provided to be seated in a receiving groove formed recessed on an inner circumferential surface of the cylinder body 1210 to be in contact with an outer circumferential surface of the second master piston 1230, and the second sealing member 1290b may prevent the pressurized medium accommodated in the first master chamber 1220a from leaking to the second master chamber 1230a.

The second master piston 1230 is provided with a second cut-off hole 1230d that communicates with the second master chamber 1230a and simultaneously communicates with the fifth hydraulic port 1280e and the second reservoir flow path 1720 in a non-operating state, that is, in a ready state before displacement occurs. In addition, between an outer circumferential surface of the second master piston 1230 and the cylinder body 1210, a fourth sealing member 1290d that blocks flow of the pressurized medium discharged from the second master chamber 1230a to the second reservoir flow path 1720 connected to the fifth hydraulic port 1280e may be provided. The fourth sealing member 1290d may be seated in a receiving groove formed recessed in front (left side based on FIG. 2) of the fifth hydraulic port 1280e on an inner circumferential surface of the cylinder body 1210 to be in contact with an outer circumferential surface of the second master piston 1230. The fourth sealing member 1290d may be provided in front (left side based on FIG. 2) of the second sealing member 1290b, and may allow flow of the pressurized medium transmitted from the second reservoir flow path 1720 connected to the fifth hydraulic port 1280e to the second master chamber 1230a, but block flow of the pressurized medium transmitted from the second master chamber 1230a to the fifth hydraulic port 1280e and the second reservoir flow path 1720.

The integrated master cylinder 1200 may secure safety in case of failure of component elements by independently having the first master chamber 1220a and the second master chamber 1230a, respectively. For example, the first master chamber 1220a is connected to any two wheel cylinders 21, 22 through the first backup flow path 1610 to be described later, and the second master chamber 1230a may be connected to the other two wheel cylinders 23, 24 through the second backup flow path 1620 to be described later. Accordingly, even when a problem such as a leak occurs in any one chamber, braking of the vehicle may be possible.

The pedal simulator 1240 may be provided between the first master piston 1220 and the second master piston 1230 to provide a pedal feel of the brake pedal 10 to the driver by its own elastic restoring force.

The pedal simulator 1240 may be interposed between a front surface of the first master piston 1220 and a rear surface of the second master piston 1230, and may be made of an elastic material such as rubber that can be compressed and expanded. The pedal simulator 1240 may include a cylindrical body portion at least partially inserted into and supported on a front surface of the first master piston 1220, and a tapered portion at least partially inserted into and supported on a rear surface of the second master piston 1230 and having a diameter gradually decreasing toward the front (left side based on FIG. 2). At least a portion of both ends of the pedal simulator 1240 may be stably supported by being inserted into the first master piston 1220 and the second master piston 1230, respectively. Furthermore, the tapered portion may give a change in elastic restoring force according to the degree of pedal force of the brake pedal 10, thereby providing a stable and familiar pedal feel to the driver.

A pedal simulation operation by the integrated master cylinder 1200 will be described. In a normal operation mode, a first cut valve 1611 and a second cut valve 1621 provided on a first backup flow path 1610 and a second backup flow path 1620 to be described later, respectively, are closed while the driver operates the brake pedal 10, while a simulator valve 1711 of the first reservoir flow path 1710 is opened. As operation of the brake pedal 10 proceeds, the first master piston 1220 moves forward, but the second master piston 1230 does not generate displacement as the second master chamber 1230a is sealed by the second cut valve 1621 closing operation. At this time, the pressurized medium accommodated in the first master chamber 1220a may flow along the first reservoir flow path 1710 by the closing operation of the first cut valve 1611 and the opening operation of the simulator valve 1711. While the second master piston 1230 cannot move forward, the first master piston 1220 continues to move forward, thereby compressing the pedal simulator 1240, and the elastic restoring force of the pedal simulator 1240 may be provided to the driver as a pedal feel. Thereafter, when the driver releases the pedal force of the brake pedal 10, the first master piston 1220 and the second master piston 1230 and the pedal simulator 1240 return to their original shape and position by the elastic restoring force of the first piston spring 1220b and the second piston spring 1230b and the pedal simulator 1240, and the first master chamber 1220a may be filled with the pressurized medium supplied from the reservoir 1100 through the first reservoir flow path 1710.

As such, since the interior of the first master chamber 1220a and the second master chamber 1230a is always filled with the pressurized medium, friction between the first master piston 1220 and the second master piston 1230 is minimized during pedal simulation operation, thereby improving durability of the integrated master cylinder 1200 as well as blocking inflow of foreign substances from the outside.

The reservoir 1100 may accommodate and store a pressurized medium inside. The reservoir 1100 is connected to the integrated master cylinder 1200, a hydraulic pressure supply device 1300 to be described later, a hydraulic circuit, and other component elements to supply or receive a pressurized medium. Although several reservoirs 1100 are shown with the same reference numerals in the drawings, this is an example for understanding the invention, and the reservoir 1100 may be provided as a single component or as a plurality of separate independent components.

The reservoir flow path 1700 may be provided to connect the integrated master cylinder 1200 and the reservoir 1100.

The reservoir flow path 1700 may include a first reservoir flow path 1710 connecting the first master chamber 1220a and the reservoir 1100, and a second reservoir flow path 1720 connecting the second master chamber 1230a and the reservoir 1100. For this purpose, one end of the first reservoir flow path 1710 may communicate with the first master chamber 1220a by the first hydraulic port 1280a of the integrated master cylinder 1200, and the other end may communicate with the reservoir 1100. One end of the second reservoir flow path 1720 may communicate with the second master chamber 1230a by the fifth hydraulic port 1280e of the integrated master cylinder 1200, and the other end may communicate with the reservoir 1100. In addition, as described above, a simulator valve 1711 that opens operation in a normal operation mode is provided in the first reservoir flow path 1710, so that flow of the pressurized medium between the reservoir 1100 and the first master chamber 1220a through the first reservoir flow path 1710 may be controlled.

The hydraulic pressure supply device 1300 may be provided to receive a driver's braking intention as an electrical signal from the first pedal sensor 11 that detects displacement of the brake pedal 10 and generate hydraulic pressure of the pressurized medium through mechanical operation.

The hydraulic pressure supply device 1300 is provided to receive a driver's braking intention as an electrical signal from a pedal displacement sensor that detects displacement of the brake pedal 10 and generate hydraulic pressure of the pressurized medium through mechanical operation.

The hydraulic pressure supply device 1300 may include a hydraulic pressure providing unit that provides pressure of the pressurized medium transmitted to the plurality of wheel cylinders 21, 22, 23, 24, a motor (not shown) that generates rotational force by an electrical signal of the pedal displacement sensor, and a power conversion unit (not shown) that converts rotational motion of the motor into linear motion and transmits it to the hydraulic pressure providing unit.

The hydraulic pressure providing unit of the hydraulic pressure supply device 1300 may include a cylinder block 1310 provided to accommodate a pressurized medium, a hydraulic piston 1320 accommodated in the cylinder block 1310, pressure chambers 1330, 1340 whose volume changes by operation of the hydraulic piston 1320, and a drive shaft 1390 that transmits power output from the power conversion unit to the hydraulic piston 1320.

The pressure chambers 1330, 1340 may include a first pressure chamber 1330 located in front (left direction of the hydraulic piston 1320 based on FIG. 2) of the hydraulic piston 1320, and a second pressure chamber 1340 located behind (right direction of the hydraulic piston 1320 based on FIG. 2) the hydraulic piston 1320. That is, the first pressure chamber 1330 is provided to be partitioned by the cylinder block 1310 and a front surface of the hydraulic piston 1320 so that the volume changes according to movement of the hydraulic piston 1320, and the second pressure chamber 1340 is provided to be partitioned by the cylinder block 1310 and a rear surface of the hydraulic piston 1320 so that the volume changes according to movement of the hydraulic piston 1320.

The first pressure chamber 1330 may be connected to a first hydraulic flow path 1401 to be described later through a first communication hole 1360a formed in the cylinder block 1310, and the second pressure chamber 1340 may be connected to a second hydraulic flow path 1402 to be described later through a second communication hole 1360b formed in the cylinder block 1310.

The sealing member may include a piston sealing member 1350a provided between the hydraulic piston 1320 and the cylinder block 1310 to seal between the first pressure chamber 1330 and the second pressure chamber 1340, and a drive shaft sealing member 1350b provided between the drive shaft 1390 and the cylinder block 1310 to seal the second pressure chamber 1340 and an opening of the cylinder block 1310. Hydraulic pressure or negative pressure of the first pressure chamber 1330 and the second pressure chamber 1340 generated by forward or backward movement of the hydraulic piston 1320 is sealed by the piston sealing member 1350a and the drive shaft sealing member 1350b and may be transmitted to the first hydraulic flow path 1401 and the second hydraulic flow path 1402 to be described later without leaking. In addition, a chamber sealing member 1350c may be provided between the second pressure chamber 1340 and the drive shaft sealing member 1350b, and the chamber sealing member 1350c may allow flow of the pressurized medium flowing into the second pressure chamber 1340 through an auxiliary inflow flow path 1850 to be described later, but block flow of the pressurized medium leaking from the second pressure chamber 1340 to the auxiliary inflow flow path 1850.

The motor 1360 is provided to generate driving force of the hydraulic piston 1320 by an electrical signal output from the controller 150. The motor 1360 may include a stator and a rotor, and through this, may provide power to generate displacement of the hydraulic piston 1320 by rotating in a forward direction or a reverse direction. A rotational angular velocity and a rotational angle of the motor 1360 may be precisely controlled by a motor control sensor (not shown). Since the motor 1360 is a well-known technology, a detailed description will be omitted.

The power conversion unit of the hydraulic pressure supply device 1300 may be provided to convert rotational force of the motor 1360 into linear motion. The power conversion unit may be provided with a structure including, for example, a worm shaft (not shown), a worm wheel (not shown), and a drive shaft 1390.

The worm shaft may be integrally formed with a rotational shaft of the motor 1360, and a worm may be formed on an outer circumferential surface to engage with the worm wheel to rotate the worm wheel. The worm wheel may be connected to engage with the drive shaft 1390 to linearly move the drive shaft 1390, and the drive shaft 1390 is connected to the hydraulic piston 1320 to operate integrally, so that the hydraulic piston 1320 may slide in the cylinder block 1310.

The above operations will be described again. When displacement is detected in the brake pedal 10 by the pedal sensor 11, the detected signal is transmitted to the controller 150, and the controller 150 may drive the motor 1360 to rotate the worm shaft in one direction. The rotational force of the worm shaft is transmitted to the drive shaft 1390 through the worm wheel, and the hydraulic piston 1320 connected to the drive shaft 1390 may move forward in the cylinder block 1310 to generate hydraulic pressure in the first pressure chamber 1330.

Conversely, when the pedal force of the brake pedal 10 is released, the first control circuit 4100 drives the motor 1360 to rotate the worm shaft in the opposite direction. Accordingly, the worm wheel also rotates in the opposite direction, and the hydraulic piston 1320 connected to the drive shaft 1390 may move backward in the cylinder block 1310 to generate negative pressure in the first pressure chamber 1330.

Generation of hydraulic pressure and negative pressure of the second pressure chamber 1340 may be implemented by operating in the opposite direction to the above. That is, when displacement is detected in the brake pedal 10 by the pedal sensor 11, the detected signal is transmitted to the controller 150, and the controller 150 may drive the motor 1360 to rotate the worm shaft in the opposite direction. The rotational force of the worm shaft is transmitted to the drive shaft 1390 through the worm wheel, and the hydraulic piston 1320 connected to the drive shaft 1390 may move backward in the cylinder block 1310 to generate hydraulic pressure in the second pressure chamber 1340.

Conversely, when the pedal force of the brake pedal 10 is released, the controller 150 may drive the motor 1360 in one direction to rotate the worm shaft in one direction. Accordingly, the worm wheel also rotates in the opposite direction, and the hydraulic piston 1320 connected to the drive shaft 1390 may move forward in the cylinder block 1310 to generate negative pressure in the second pressure chamber 1340.

As such, in the hydraulic pressure supply device 1300, hydraulic pressure or negative pressure may be generated in the first pressure chamber 1330 and the second pressure chamber 1340, respectively, according to the rotation direction of the worm shaft by driving of the motor 1360. Whether to implement braking by transmitting hydraulic pressure or release braking using negative pressure may be determined by controlling valves. A detailed description thereof will be given later.

Meanwhile, the power conversion unit according to the present embodiment is not limited to any one structure as long as it can convert rotational motion of the motor 1360 into linear motion of the hydraulic piston 1320, and it should be understood in the same way even when it is made of devices of various structures and methods.

The hydraulic pressure supply device 1300 may be hydraulically connected to the reservoir 1100 by the dump control unit 1800. The dump control unit 1800 may include a first dump control unit that controls flow of the pressurized medium between the first pressure chamber 1330 and the reservoir 1100, and a second dump control unit that controls flow of the pressurized medium between the second pressure chamber 1340 and the reservoir 1100. The first dump control unit may include a first dump flow path 1810 connecting the first pressure chamber 1330 and the reservoir 1100, and a first bypass flow path 1830 branching and rejoining on the first dump flow path 1810. The second dump control unit may include a second dump flow path 1820 connecting the second pressure chamber 1340 and the reservoir 1100, and a second bypass flow path 1840 branching and rejoining on the second dump flow path 1820.

A first dump check valve 1811 and a first dump valve 1831 that control flow of the pressurized medium may be provided on the first dump flow path 1810 and the first bypass flow path 1830, respectively. The first dump check valve 1811 may be provided to allow only flow of the pressurized medium from the reservoir 1100 to the first pressure chamber 1330 and block flow of the pressurized medium in the opposite direction. The first bypass flow path 1830 is connected in parallel to the first dump check valve 1811 on the first dump flow path 1810, and a first dump valve 1831 that controls flow of the pressurized medium between the first pressure chamber 1330 and the reservoir 1100 may be provided on the first bypass flow path 1830. In other words, the first bypass flow path 1830 may bypass and connect a front end and a rear end of the first dump check valve 1811 on the first dump flow path 1810, and the first dump valve 1831 may be provided as a bidirectional solenoid valve that controls flow of the pressurized medium between the first pressure chamber 1330 and the reservoir 1100. The first dump valve 1831 may be provided as a normally closed type solenoid valve that is in a closed state normally and operates to open a valve when receiving an electrical signal from the controller 150.

A second dump check valve 1821 and a second dump valve 1841 that control flow of the pressurized medium may be provided on the second dump flow path 1820 and the second bypass flow path 1840, respectively. The second dump check valve 1821 may be provided to allow only flow of the pressurized medium from the reservoir 1100 to the second pressure chamber 1330 and block flow of the pressurized medium in the opposite direction. The second bypass flow path 1840 is connected in parallel to the second dump check valve 1821 on the second dump flow path 1820, and a second dump valve 1841 that controls flow of the pressurized medium between the second pressure chamber 1330 and the reservoir 1100 may be provided on the second bypass flow path 1840. In other words, the second bypass flow path 1840 may bypass and connect a front end and a rear end of the second dump check valve 1821 on the second dump flow path 1820, and the second dump valve 1841 may be provided as a bidirectional solenoid valve that controls flow of the pressurized medium between the second pressure chamber 1330 and the reservoir 1100. The second dump valve 1841 may be provided as a normally open type solenoid valve that is normally open and operates to close a valve when receiving an electrical signal from the controller 150.

In addition, the dump control unit 1800 may include an auxiliary inflow flow path 1850 connecting the reservoir 1100 and the second pressure chamber 1340 so that the pressurized medium can be filled in the second pressure chamber 1340. The auxiliary inflow flow path 1850 may be connected to a rear (right side based on FIG. 2) of the chamber sealing member 1350c on the cylinder block 1310. Thereby, the pressurized medium may flow from the reservoir 1100 to the second pressure chamber 1340 through the auxiliary inflow flow path 1850, but flow of the pressurized medium leaking from the second pressure chamber 1340 to the auxiliary inflow flow path 1850 may be blocked by the chamber sealing member 1350c.

The hydraulic control unit 1400 may be provided to control flow of the pressurized medium toward each wheel cylinder 21, 22, 23, 24 or flow of the pressurized medium recovered from each wheel cylinder 21, 22, 23, 24 to the hydraulic pressure supply device 1300.

For this purpose, the hydraulic control unit 1400 may include a plurality of flow paths and a plurality of valves that can allow or block flow of the pressurized medium in the plurality of flow paths to smoothly control flow or hydraulic pressure of the pressurized medium.

Specifically, the hydraulic control unit 1400 may include a first hydraulic circuit 1510 that controls flow of hydraulic pressure transmitted to a first wheel cylinder 21 and a second wheel cylinder 22 among the four wheel cylinders 21, 22, 23, 24, and a second hydraulic circuit 1520 that controls flow of hydraulic pressure transmitted to a third wheel cylinder 23 and a fourth wheel cylinder 24, and may include a plurality of flow paths and valves to control hydraulic pressure transmitted from the hydraulic pressure supply device 1300 to the wheel cylinders 21, 22, 23, 24.

The first hydraulic flow path 1401 is provided to communicate with the first pressure chamber 1330, and the second hydraulic flow path 1402 may be provided to communicate with the second pressure chamber 1340. The first hydraulic flow path 1401 and the second hydraulic flow path 1402 may merge into a third hydraulic flow path 1403, and then may be provided to branch again into a fourth hydraulic flow path 1404 connected to the first hydraulic circuit 1510 and a fifth hydraulic flow path 1405 connected to the second hydraulic circuit 1520.

The sixth hydraulic flow path 1406 is provided to communicate with the first hydraulic circuit 1510, and the seventh hydraulic flow path 1407 may be provided to communicate with the second hydraulic circuit 1520. The sixth hydraulic flow path 1406 and the seventh hydraulic flow path 1407 may merge into an eighth hydraulic flow path 1408, and then may be provided to branch again into a ninth hydraulic flow path 1409 communicating with the first pressure chamber 1330 and a tenth hydraulic flow path 1410 communicating with the second pressure chamber 1340.

A first valve 1431 that controls flow of the pressurized medium may be provided on the first hydraulic flow path 1401. The first valve 1431 may be provided as a check valve that allows flow of the pressurized medium discharged from the first pressure chamber 1330 but blocks flow of the pressurized medium in the opposite direction. In addition, a second valve 1432 that controls flow of the pressurized medium may be provided on the second hydraulic flow path 1402, and the second valve 1432 may be provided as a check valve that allows flow of the pressurized medium discharged from the second pressure chamber 1340 but blocks flow of the pressurized medium in the opposite direction.

The fourth hydraulic flow path 1404 may be provided to branch again from the third hydraulic flow path 1403 where the first hydraulic flow path 1401 and the second hydraulic flow path 1402 merge and connect to the first hydraulic circuit 1510. A third valve 1433 that controls flow of the pressurized medium may be provided on the fourth hydraulic flow path 1404. The third valve 1433 may be provided as a check valve that allows only flow of the pressurized medium from the third hydraulic flow path 1403 to the first hydraulic circuit 1510 and blocks flow of the pressurized medium in the opposite direction.

The fifth hydraulic flow path 1405 may be provided to branch again from the third hydraulic flow path 1403 where the first hydraulic flow path 1401 and the second hydraulic flow path 1402 merge and connect to the second hydraulic circuit 1520. A fourth valve 1434 that controls flow of the pressurized medium may be provided on the fifth hydraulic flow path 1405. The fourth valve 1434 may be provided as a check valve that allows only flow of the pressurized medium from the third hydraulic flow path 1403 to the second hydraulic circuit 1520 and blocks flow of the pressurized medium in the opposite direction.

The sixth hydraulic flow path 1406 may communicate with the first hydraulic circuit 1510, the seventh hydraulic flow path 1407 may communicate with the second hydraulic circuit 1520, and may be provided to merge into the eighth hydraulic flow path 1408. A fifth valve 1435 that controls flow of the pressurized medium may be provided on the sixth hydraulic flow path 1406. The fifth valve 1435 may be provided as a check valve that allows only flow of the pressurized medium discharged from the first hydraulic circuit 1510 and blocks flow of the pressurized medium in the opposite direction. In addition, a sixth valve 1436 that controls flow of the pressurized medium may be provided on the seventh hydraulic flow path 1407. The sixth valve 1436 may be provided as a check valve that allows only flow of the pressurized medium discharged from the second hydraulic circuit 1520 and blocks flow of the pressurized medium in the opposite direction.

The ninth hydraulic flow path 1409 may be provided to branch from the eighth hydraulic flow path 1408 where the sixth hydraulic flow path 1406 and the seventh hydraulic flow path 1407 merge and connect to the first pressure chamber 1330. A seventh valve 1437 that controls flow of the pressurized medium may be provided on the ninth hydraulic flow path 1409. The seventh valve 1437 may be provided as a bidirectional control valve that controls flow of the pressurized medium transmitted along the ninth hydraulic flow path 1409. The seventh valve 1437 may be provided as a normally closed type solenoid valve that is in a closed state normally and operates to open a valve when receiving an electrical signal from the controller 150.

The tenth hydraulic flow path 1410 may be provided to branch from the eighth hydraulic flow path 1408 where the sixth hydraulic flow path 1406 and the seventh hydraulic flow path 1407 merge and connect to the second pressure chamber 1340. An eighth valve 1438 that controls flow of the pressurized medium may be provided on the tenth hydraulic flow path 1410. The eighth valve 1438 may be provided as a bidirectional control valve that controls flow of the pressurized medium transmitted along the tenth hydraulic flow path 1410. The eighth valve 1438, like the seventh valve 1437, may be provided as a normally closed type solenoid valve that is in a closed state normally and operates to open a valve when receiving an electrical signal from the controller 150.

According to the plurality of hydraulic flow paths and the plurality of valves described above, hydraulic pressure formed in the first pressure chamber 1330 by forward movement of the hydraulic piston 1320 may be transmitted to the first hydraulic circuit 1510 through the first hydraulic flow path 1401, the third hydraulic flow path 1403, and the fourth hydraulic flow path 1404 sequentially, and may be transmitted to the second hydraulic circuit 1520 through the first hydraulic flow path 1401 and the fifth hydraulic flow path 1405 sequentially. In addition, hydraulic pressure formed in the second pressure chamber 1340 according to backward movement of the hydraulic piston 1320 may be transmitted to the first hydraulic circuit 1510 through the second hydraulic flow path 1402 and the fourth hydraulic flow path 1404 sequentially, and may be transmitted to the second hydraulic circuit 1520 through the second hydraulic flow path 1402, the third hydraulic flow path 1403, and the fifth hydraulic flow path 1405 sequentially.

Conversely, negative pressure formed in the first pressure chamber 1330 according to backward movement of the hydraulic piston 1320 may cause the pressurized medium provided to the first hydraulic circuit 1510 to be recovered to the first pressure chamber 1330 through the sixth hydraulic flow path 1406, the eighth hydraulic flow path 1408, and the ninth hydraulic flow path 1409 sequentially, and may cause the pressurized medium provided to the second hydraulic circuit 1520 to be recovered to the first pressure chamber 1330 through the seventh hydraulic flow path 1407, the eighth hydraulic flow path 1408, and the ninth hydraulic flow path 1409 sequentially. In addition, negative pressure formed in the second pressure chamber 1340 according to forward movement of the hydraulic piston 1320 may cause the pressurized medium provided to the first hydraulic circuit 1510 to be recovered to the second pressure chamber 1340 through the sixth hydraulic flow path 1406, the eighth hydraulic flow path 1408, and the tenth hydraulic flow path 1410 sequentially, and may cause the pressurized medium provided to the second hydraulic circuit 1520 to be recovered to the second pressure chamber 1340 through the seventh hydraulic flow path 1407, the eighth hydraulic flow path 1408, and the tenth hydraulic flow path 1410 sequentially.

The first hydraulic circuit 1510 of the hydraulic control unit 1400 may adjust and/or control hydraulic pressure of the first wheel cylinder 21 and the second wheel cylinder 22 among the four wheel cylinders 21, 22, 23, 24, and the second hydraulic circuit 1520 may adjust and/or control hydraulic pressure of the third wheel cylinder 23 and the fourth wheel cylinder 24 among the four wheel cylinders 21, 22, 23, 24.

The first hydraulic circuit 1510 may receive hydraulic pressure through the fourth hydraulic flow path 1404 and discharge hydraulic pressure through the sixth hydraulic flow path 1406. For this purpose, as shown in FIG. 2, the fourth hydraulic flow path 1404 and the sixth hydraulic flow path 1406 may be provided to merge and then branch into two flow paths connected to the first wheel cylinder 21 and the second wheel cylinder 22. In addition, the second hydraulic circuit 1520 may receive hydraulic pressure through the fifth hydraulic flow path 1405 and discharge hydraulic pressure through the seventh hydraulic flow path 1407. Accordingly, as shown in FIG. 2, the fifth hydraulic flow path 1405 and the seventh hydraulic flow path 1407 may merge and then may be provided to branch into two flow paths connected to the third wheel cylinder 23 and the fourth wheel cylinder 24. However, the connection of the hydraulic flow paths shown in FIG. 2 is an example for understanding the present invention and is not limited to that structure. The fourth hydraulic flow path 1404 and the sixth hydraulic flow path 1406 may be respectively connected to the first hydraulic circuit 1510 side and may be independently branched and connected to the first wheel cylinder 21 and the second wheel cylinder 22. Similarly, the fifth hydraulic flow path 1405 and the seventh hydraulic flow path 1407 may be respectively connected to the second hydraulic circuit 1520 side and may be independently branched and connected to the third wheel cylinder 23 and the fourth wheel cylinder 24, and it should be understood in the same way even when connected in various ways and structures.

The first hydraulic circuit 1510 and the second hydraulic circuit 1520 may each have first to fourth inlet valves 1511a, 1511b, 1521a, 1521b to control flow and hydraulic pressure of the pressurized medium transmitted to the first to fourth wheel cylinders 21, 22, 23, 24. The first to fourth inlet valves 1511a, 1511b, 1521a, 1521b are respectively disposed upstream of the first to fourth wheel cylinders 21, 22, 23, 24 and may be provided as normally open type solenoid valves that are normally open and operate to close a valve when receiving an electrical signal from the controller 150.

The first hydraulic circuit 1510 and the second hydraulic circuit 1520 may include first to fourth check valves 1513a, 1513b, 1523a, 1523b connected in parallel to the first to fourth inlet valves 1511a, 1511b, 1521a, 1521b. Each of the first to fourth check valves 1513a, 1513b, 1523a, 1523b may be provided on a bypass flow path connecting front and rear of the first to fourth inlet valves 1511a, 1511b, 1521a, 1521b on the first hydraulic circuit 1510 and the second hydraulic circuit 1520, and may allow only flow of the pressurized medium from the first to fourth wheel cylinders 21, 22, 23, 24 to the hydraulic pressure supply device 1300 and block flow of the pressurized medium from the hydraulic pressure supply device 1300 to the first to fourth wheel cylinders 21, 22, 23, 24. By the first to fourth check valves 1513a, 1513b, 1523a, 1523b, hydraulic pressure of the pressurized medium applied to each of the first to fourth wheel cylinders 21, 22, 23, 24 may be quickly removed, and even when the first to fourth inlet valves 1511a, 1511b, 1521a, 1521b do not operate normally, hydraulic pressure of the pressurized medium applied to each of the first to fourth wheel cylinders 21, 22, 23, 24 may smoothly return to the hydraulic pressure providing unit.

The second hydraulic circuit 1520 may have a first outlet valve 1522a and a second outlet valve 1522b that control flow of the pressurized medium discharged from the third wheel cylinder 23 and the fourth wheel cylinder 24 to improve performance when releasing braking of the third wheel cylinder 23 and the fourth wheel cylinder 24. The first outlet valve 1522a and the second outlet valve 1522b may be respectively provided on discharge sides of the third wheel cylinder 23 and the fourth wheel cylinder 24 to control flow of the pressurized medium transmitted from the third wheel cylinder 23 and the fourth wheel cylinder 24 to the reservoir 1100. The first outlet valve 1522a and the second outlet valve 1522b may be provided as normally closed type solenoid valves that are in a closed state normally and operate to open a valve when receiving an electrical signal from the controller 150. The first outlet valve 1522a and the second outlet valve 1522b may selectively release hydraulic pressure of the pressurized medium applied to the third wheel cylinder 23 and the fourth wheel cylinder 24 and transmit it to the reservoir 1100 side during ABS braking mode of the vehicle.

The first wheel cylinder 21 and the second wheel cylinder 22 of the first hydraulic circuit 1510 may be branched and connected to a first backup flow path 1610 to be described later, and at least one first cut valve 1611 may be provided on the first backup flow path 1610 to control flow of the pressurized medium between the first wheel cylinder 21 and the second wheel cylinder 22 and the integrated master cylinder 1200.

The electronic brake system 1000 according to the first embodiment of the present invention may include a first backup flow path 1610 and a second backup flow path 1620 so that when normal operation is impossible due to device failure or the like, braking may be implemented by directly supplying the pressurized medium discharged from the integrated master cylinder 1200 to the wheel cylinders 21, 22, 23, 24. A mode in which hydraulic pressure of the integrated master cylinder 1200 is directly transmitted to the wheel cylinders 21, 22, 23, 24 is called an abnormal operation mode, that is, a fallback mode.

The first backup flow path 1610 may be provided to connect the first master chamber 1220a of the integrated master cylinder 1200 and the first hydraulic circuit 1510, and the second backup flow path 1620 may be provided to connect the second master chamber 1230a of the integrated master cylinder 1200 and the second hydraulic circuit 1520.

One end of the first backup flow path 1610 may be connected to the first master chamber 1220a, and the other end may be branched and connected to downstream sides of the first inlet valve 1511a and the second inlet valve 1511b on the first hydraulic circuit 1510. One end of the second backup flow path 1620 may be connected to the second master chamber 1230a, and the other end may be connected between the fourth inlet valve 1522b and the second outlet valve 1522b on the second hydraulic circuit 1520.

In FIG. 2, the second backup flow path 1620 is shown as being connected between the fourth inlet valve 1522b and the second outlet valve 1522b, but it should be understood in the same way if the second backup flow path 1620 branches and is connected to at least any one of upstream sides of the first outlet valve 1522a and the second outlet valve 1522b.

At least one first cut valve 1611 that controls bidirectional flow of the pressurized medium may be provided on the first backup flow path 1610, and a second cut valve 1621 that controls bidirectional flow of the pressurized medium may be provided on the second backup flow path 1620. The first cut valve 1611 and the second cut valve 1621 may be provided as normally open type solenoid valves that are normally open and operate to close a valve when receiving a closing signal from the controller 150.

As shown in FIG. 2, a pair of first cut valves 1611 may be provided on the first and second wheel cylinder 21, 22 sides, respectively, and during ABS braking mode of the vehicle, hydraulic pressure of the pressurized medium applied to the first wheel cylinder 21 and the second wheel cylinder 22 may be selectively released and discharged to the reservoir 1100 side through the first backup flow path 1610, the first master chamber 1220a, the second branch flow path 1920 to be described later, and the dump control unit 1800. A detailed description thereof will be given later.

When closing the first cut valve 1611 and the second cut valve 1621, it is possible to prevent the pressurized medium of the integrated master cylinder 1200 from being directly transmitted to the wheel cylinder 20 and simultaneously prevent hydraulic pressure provided from the hydraulic pressure supply device 1300 from leaking to the integrated master cylinder 1200 side.

In addition, when opening the first cut valve 1611 and the second cut valve 1621, the pressurized medium pressurized in the integrated master cylinder 1200 may be directly supplied to the first hydraulic circuit 1510 and the second hydraulic circuit 1520 side through the first backup flow path 1610 and the second backup flow path 1620 to implement braking.

The inspection flow path 1900 may be provided to connect the integrated master cylinder 1200 and the hydraulic pressure supply device 1300 to inspect whether various component elements mounted on the integrated master cylinder 1200 and the simulator valve 1711 leak.

One end of the inspection flow path 1900 may be connected to the second pressure chamber 1340, and the other end may be branched into a first branch flow path 1910 and a second branch flow path 1920 to be respectively connected to the first master chamber 1220a through the third hydraulic port 1280c and the fourth hydraulic port 1280d. One end of the inspection flow path 1900 may be directly connected to the second pressure chamber 1340, or may be connected to the second pressure chamber 1340 via the second dump flow path 1820 as shown in FIG. 2.

An inspection valve 1911 that controls bidirectional flow of the pressurized medium between the first master chamber 1220a and the second pressure chamber 1340 may be provided on the first branch flow path 1910, and an inspection check valve 1921 that allows only flow of the pressurized medium from the first master chamber 1220a to the second pressure chamber 1340 and blocks flow of the pressurized medium in the opposite direction may be provided on the second branch flow path 1920. The inspection valve 1911 may be provided as a normally open type solenoid valve that is normally open and operates to close a valve when receiving an electrical signal from the controller 150. The inspection valve 1911 may be controlled in a closed state in a first inspection mode of the electronic brake system 1000 and may be controlled in an open state in a second inspection mode. A detailed description thereof will be given later.

The electronic brake system 1000 may include a circuit pressure sensor PS1 that detects hydraulic pressure of the pressurized medium provided by the hydraulic pressure supply device 1300, and a cylinder pressure sensor PS2 that detects hydraulic pressure of the second master chamber 1230a.

The circuit pressure sensor PS1 may be provided on the first hydraulic circuit 1510 side to detect hydraulic pressure of the pressurized medium generated and provided from the hydraulic pressure supply device 1300 and transmitted to the first hydraulic circuit 1510 during inspection mode. For example, the circuit pressure sensor PS1 may be provided on the fourth hydraulic flow path 1404.

The cylinder pressure sensor PS2 may be provided between the second master chamber 1230a and the second cut valve 1621 on the second backup flow path 1620 to detect hydraulic pressure of the pressurized medium accommodated in the second master chamber 1230a.

Pressure numerical information of the pressurized medium detected by at least one of the circuit pressure sensor PS1 and the cylinder pressure sensor PS2 may be transmitted to the controller 150. For example, during a brake inspection mode to be described later, pressure numerical information of the pressurized medium detected by the circuit pressure sensor PS1 may be transmitted to the controller 150.

The controller 150 may determine whether the integrated master cylinder 1200 or the simulator valve 1711 leaks by comparing a hydraulic pressure value detected by the circuit pressure sensor PS1 with a hydraulic pressure value detected by the cylinder pressure sensor PS2.

In addition, the brake module 100 may include a motor position sensor 1370 that detects a rotational position of the motor 1360 of the hydraulic pressure supply device 1300. For example, during brake inspection mode, rotational position information of the motor 1360 detected by the motor position sensor 1370 may be transmitted to the controller 150. Here, the controller 150 of the brake module 100 may operate the motor 1360 of the hydraulic pressure supply device 1300 based on the target braking pressure to generate hydraulic pressure, and at this time may measure hydraulic pressure provided to each wheel cylinder 21, 22, 23, 24. The controller 150 may know an operation amount (stroke distance, rotational position, etc.) of the motor 1360 based on an output signal of the motor position sensor 1370 and may know pressure applied to each wheel cylinder 21, 22, 23, 24.

The controller 150 may include a plurality of semiconductor elements and may be called variously such as an electronic controller unit (ECU). The controller 150 may include, for example, one or more processors 151 and one or more memories 152.

The controller 150 may receive a signal corresponding to a user's braking intention from the pedal sensor 11, and in response thereto, may provide electrical signals to the hydraulic pressure supply device 1300 and the hydraulic control unit 1400, respectively, to supply or recover hydraulic pressure to each wheel cylinder 21, 22, 23, 24.

The memory 152 may store or remember programs and data for implementing operations to control components included in the electronic brake system 1000.

The memory 152 may provide the stored programs and data to the processor 151 and may remember temporary data generated during operation of the processor 151. For example, the memory 152 may include volatile memory such as static random access memory (S-RAM) and dynamic random access memory (D-RAM), and non-volatile memory such as read only memory (ROM), erasable programmable read only memory (EPROM), and flash memory.

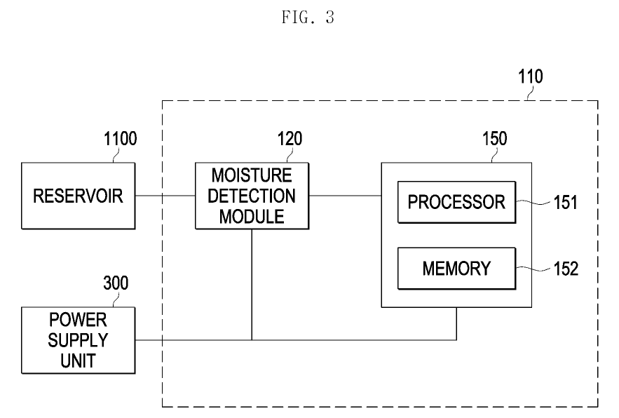

Referring to FIG. 3, the moisture detection apparatus 110 may include a moisture detection module 120 and a controller 150. Here, the controller 150 may be an ECU of the brake module 100, but is not limited thereto and may be various ECUs included as components of the vehicle 1.

The moisture detection module 120 detects moisture content of a pressurized medium (brake oil) and outputs a signal therefor, and the controller 150 may identify the moisture content of the pressurized medium based on an output signal of the moisture detection module 120.

While the present disclosure primarily describes application to brake oil, the moisture detection apparatus and method can be applied to other pressurized media or hydraulic fluids (such as other types of hydraulic oil, coolant, etc.). The electrical characteristic changes caused by moisture content in these fluids can be detected using similar principles, providing broad applicability of the disclosed technology.

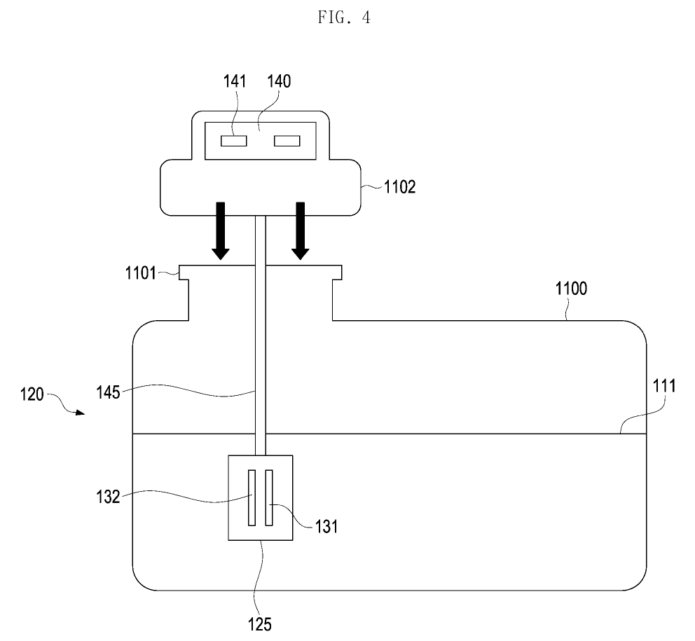

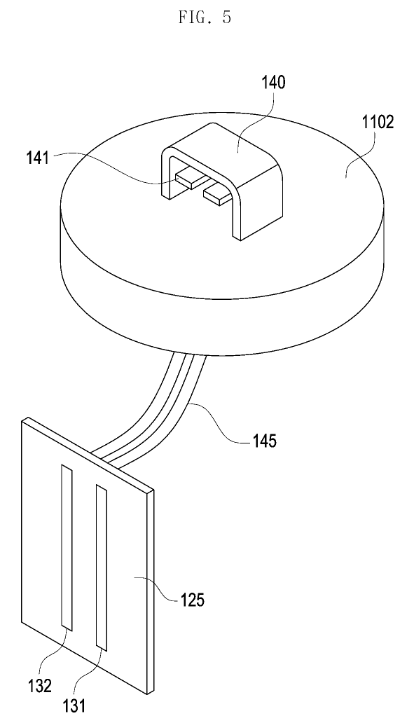

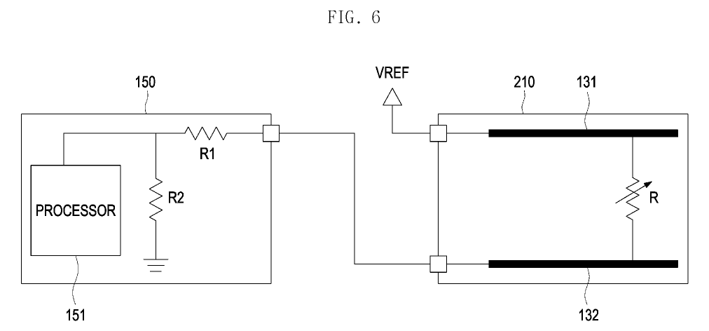

As shown in FIGS. 4 and 5, the moisture detection module 120 may include a substrate 125, a plurality of electrode patterns 131, 132, a connector 140, and a signal line 145.

The substrate 125 may be a printed circuit board (PCB). On the substrate 125, a plurality of electrode patterns 131, 132 that can be used to identify moisture content of the pressurized medium 111 stored in the reservoir 1100 may be disposed. The substrate 125 may be used as a basic structure on which the plurality of electrode patterns 131, 132 are disposed. The substrate 125 may be disposed in a state submerged in the pressurized medium 111 stored in the reservoir 1100 so that the plurality of electrode patterns 131, 132 can contact the pressurized medium 111.

The plurality of electrode patterns 131, 132 are conductive patterns formed on the substrate 125, and may include a first electrode pattern 131 to which a reference voltage is applied and a second electrode pattern 132 for monitoring. The plurality of electrode patterns 131, 132 may be provided on the substrate 125 to maintain a state submerged in the pressurized medium 111 to detect moisture contained in the pressurized medium 111.

The plurality of electrode patterns 131, 132 may extend linearly along one axial direction of the substrate 125. In addition, each of the plurality of electrode patterns 131, 132 may be disposed spaced apart from each other on at least one surface of the substrate 125. For example, each of the plurality of electrode patterns 131, 132 may be provided on at least one surface of the substrate 125 with a pattern width and spacing of about 0.5 mm and about 0.3 mm, respectively, and a length of about 30 mm. This may be set according to the processor 151 of the controller 150 to secure sufficient measurement sensitivity for moisture content of the pressurized medium 111.

The connector 140 may be integrally provided on a reservoir cap 1102 coupled to an upper end of the reservoir 1100. The connector 140 may include a plurality of terminals 141 provided to be connected to the controller 150 and the power supply unit 300. The connector 140 may play a role of supplying power to at least one of the plurality of electrode patterns 131, 132 and transmitting a signal output from at least one of the plurality of electrode patterns 131, 132 to the controller 150.

The signal line 145 may electrically connect the plurality of electrode patterns 131, 132 and the connector 140. The signal line 145 may be designed as the shortest distance to minimize noise effects, and if necessary, may prevent electromagnetic interference through shield processing.

In the present invention, moisture content may be detected using electrical characteristics of the pressurized medium 111. Moisture changes the electrical conductivity or impedance of the pressurized medium 111, and the present disclosure detects these electrical property changes through measurements such as resistance between electrodes. By utilizing these electrical characteristics, the present invention can accurately detect moisture content of the pressurized medium 111 by measuring changes in electrical characteristics according to moisture content of the pressurized medium 111.

The plurality of electrode patterns 131, 132 may include a first electrode pattern 131 and a second electrode pattern 132. The first electrode pattern 131 is a pattern to which a reference voltage VREF is applied, and may be connected to an ignition signal of the vehicle to apply a constant voltage of about 12.5V. The reference voltage is supplied stabilized through a regulator circuit and may be used as a reference for measuring electrical characteristics of the pressurized medium 111.

The second electrode pattern 132 is a pattern that measures a monitoring voltage VMON, and may detect voltage changes according to moisture content of the pressurized medium. The second electrode pattern 132 may be disposed with a set spacing from the first electrode pattern 131. Output voltage of the second electrode pattern 132 may change according to electrical characteristics of the pressurized medium 111 existing between the first electrode pattern 131.

The moisture detection apparatus 110 may identify moisture content of the pressurized medium 111 through the following process. First, when a reference voltage VREF of about 12.5V is applied to the first electrode pattern 131, the reference voltage VREF may be transmitted to the second electrode pattern 132 through the pressurized medium 111. At this time, resistance value between the first electrode pattern 131 and the second electrode pattern 132 changes according to moisture content in the pressurized medium 111, which may appear as a change in voltage value measured by the second electrode pattern 132.

The controller 150 may identify moisture content of the pressurized medium 111 based on monitoring of voltage VMON (referred to as monitoring voltage) of a circuit electrically connected to the second electrode pattern 132, for example, a pull-down circuit, while power is supplied from the power supply unit 300.

For example, the controller 150 may control the power supply unit 300 or request the power supply unit 300 to apply a voltage of a predetermined size, that is, a constant voltage, to the first electrode pattern 131. A resistor R1 limits current and regulates the voltage applied to the first electrode pattern 131, inducing a voltage drop based on the resistance change between the electrode patterns and the pressurized medium. Together with a resistor R2, the resistor R1 forms a voltage divider circuit that enables monitoring of the voltage at the second electrode pattern 132. The controller 150 may perform circuit protection and current limiting functions through the resistor R1.

In addition, the controller 150 may implement a pull-down circuit by being connected to ground (GND) through the resistor R2 to set a reference potential of the circuit and maintain voltage of the second electrode pattern 132 at 0V when there is no moisture.

The controller 150 may monitor whether voltage VMON of the pull-down circuit electrically connected to the second electrode pattern 132 is equal to or higher than a predetermined reference voltage while the reference voltage VREF is applied to the first electrode pattern 131.

When voltage VMON of the pull-down circuit electrically connected to the second electrode pattern 132 is equal to or higher than the reference voltage, the controller 150 may determine that moisture is contained in the pressurized medium 111.

As moisture content in the pressurized medium 111 increases, resistance value tends to decrease, and accordingly, voltage measured by the second electrode pattern 132 may increase. Furthermore, voltage change in the second electrode pattern 132 may be corrected through a temperature compensation circuit and a stable measurement value may be obtained through a filtering process.

The controller 150 may continuously monitor voltage generated in the second electrode pattern 132. The controller 150 may generate a monitoring signal based on an output signal (monitoring voltage) of the second electrode pattern 132. The controller 150 may compare the monitoring signal with preset reference data and identify moisture content of the pressurized medium 111 based on a comparison result.

Here, the reference data may include at least one of a reference voltage level, a reference current level, and a reference matching resistance value between the plurality of electrode patterns corresponding to moisture content of the pressurized medium 111. Such reference data may be recorded as a lookup table and stored in the memory 152 through a development stage, separate experiment, or inspection. In other words, the memory 152 may store in advance a lookup table in which reference data is recorded.

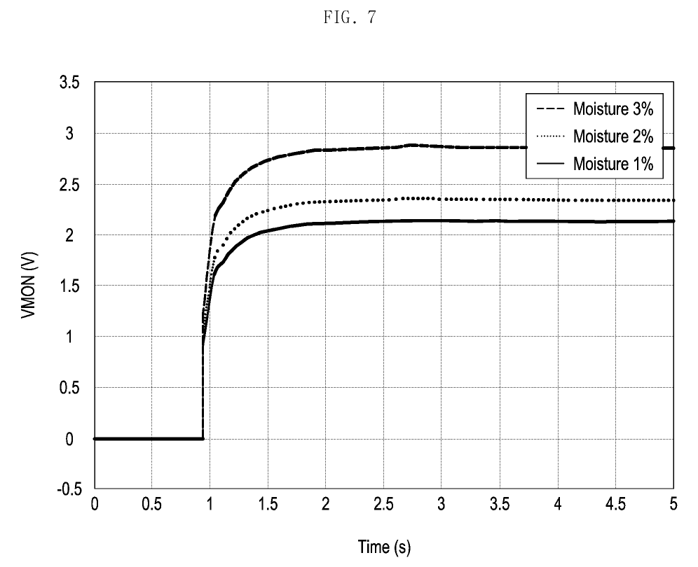

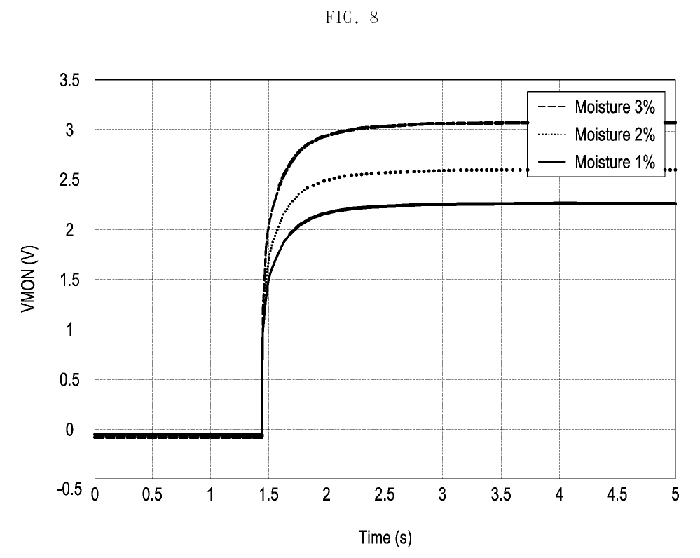

The reference voltage level, reference current level, and reference matching resistance value in the present invention will be described in detail with reference to FIGS. 7 and 8.

FIG. 7 shows reference voltage levels according to moisture content based on DOT-3 standard brake oil. FIG. 8 shows reference voltage levels according to moisture content based on DOT-4 standard brake oil. The horizontal axis represents measurement time (Time), and the vertical axis represents monitoring voltage VMON.

Reference voltage levels may exhibit different characteristics depending on the type and moisture content of brake oil. For example, in the case of DOT-3 standard brake oil, as can be confirmed in FIG. 7, it may be set to an increased voltage value as moisture content increases, such as about 2.1V when moisture content is about 1%, about 2.3V when about 2%, and about 2.8V when about 3%.

In the case of DOT-4 standard brake oil, as shown in FIG. 8, it may be set to a voltage value that is generally higher than DOT-3 standard brake oil, such as about 2.3V when moisture content is about 1%, about 2.6V when about 2%, and about 3.1V when about 3%. This is due to viscosity characteristics of DOT-4 standard brake oil, and it shows different electrical characteristics from DOT-3 standard brake oil even at the same moisture content.

Reference current level means a current value generated from a reference voltage of about 12.5V applied to the electrode pattern. In the case of DOT-3 standard brake oil, it may be set to a current of about 0.17 mA at moisture content of about 1%, about 0.19 mA at about 2%, and about 0.22 mA at about 3%. In the case of DOT-4 standard brake oil, it may be set to a current of about 0.18 mA at moisture content of about 1%, about 0.21 mA at about 2%, and about 0.25 mA at about 3%. This may be set to a slightly higher current value than DOT-3 standard brake oil.

Reference matching resistance value is an equivalent resistance value formed between electrode patterns and can be calculated from applied voltage and measured current. In the case of DOT-3 standard brake oil, it may be set to a resistance value of about 73.5 kΩ when moisture content is about 1%, about 65.8 kΩ when about 2%, and 56.8 kΩ when about 3%. In the case of DOT-4 standard brake oil, it may be set to a resistance value of about 69.4 kΩ when moisture content is about 1%, about 59.5 kΩ when 2%, and about 49.6 kΩ when 3%. In particular, as moisture content increases, reference matching resistance value may tend to decrease.

Reference matching resistance value may be calculated by a relational expression of R = VREF × (VREF - VMON) / VMON. Here, R is reference matching resistance value, VREF is reference voltage (12.5V), and VMON may be set as measured monitoring voltage.

These reference values are values measured under room temperature (25°C) conditions, and correction according to temperature change may be necessary in actual vehicle operation environment. Voltage decreases by about 0.2% each time temperature rises by about 1°C, and accordingly current and resistance values also change. To compensate for this temperature dependence, a correction coefficient in a range of about -20°C to about 80°C may be applied.

The controller 150 may output a warning signal when moisture content of the pressurized medium 111 exceeds a preset threshold value. For example, a threshold value for identified moisture content of the pressurized medium 111 may be set to about 3%. If moisture content is 3% or more, the controller 150 may output a warning signal requiring brake oil replacement.

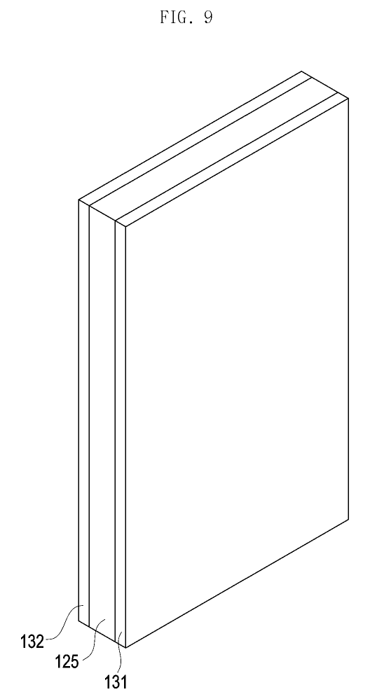

Meanwhile, as shown in FIG. 9, in a moisture detection module 120 according to another embodiment of the disclosed invention, a first electrode pattern 131 may be provided on one surface of a substrate 125, and a second electrode pattern 132 may be provided on another surface of the substrate 125.

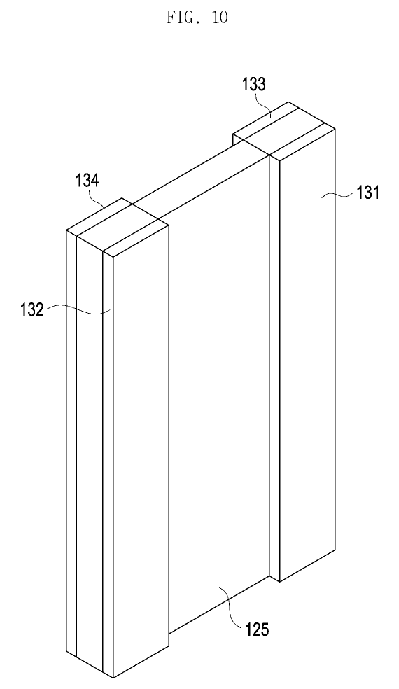

In addition, as shown in FIG. 10, in a moisture detection module 120 according to still another embodiment of the disclosed invention, a first electrode pattern 131 and a third electrode pattern 133 may be provided on one surface of a substrate 125, and a second electrode pattern 132 and a fourth electrode pattern 134 may be provided on another surface of the substrate 125.

The first electrode pattern 131 and the third electrode pattern 133 may be provided on one surface of the substrate 125 spaced apart from each other at a set spacing. The second electrode pattern 132 and the fourth electrode pattern 134 may be provided on another surface of the substrate 125 spaced apart from each other at a set spacing.

Here, the third electrode pattern 133 and the fourth electrode pattern 134 may play a redundancy role of the first electrode pattern 131 and the second electrode pattern 132.

The third electrode pattern 133, like the first electrode pattern 131, is a pattern to which a reference voltage VREF is applied, and the fourth electrode pattern 134, like the second electrode pattern 132, may be a pattern that measures monitoring voltage VMON.

Through this, the controller 150 may compare a value measured by the second electrode pattern 132 with a value measured by the fourth electrode pattern 134, and identify measurement error or failure of the moisture detection module 120 when a difference in measurement values exceeds an allowable range based on a comparison result.

In addition, the controller 150 may detect whether a pattern is damaged through a sudden change or abnormal value of a measurement value.

In addition, the controller 150 may more accurately identify moisture content of the pressurized medium 111 by simultaneously measuring on both surfaces of the substrate 125.

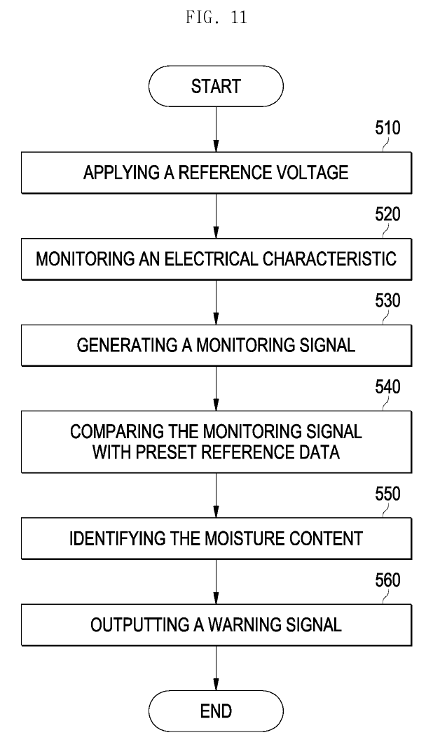

FIG. 11 is a diagram showing a moisture detection method according to an embodiment of the disclosed invention.

Referring to FIG. 11, the moisture detection apparatus 110 may apply a reference voltage to at least one of a plurality of electrode patterns 131, 132 (510). A reference voltage VREF of about 12.5V may be applied to the first electrode pattern 131 among the plurality of electrode patterns 131, 132.

The moisture detection apparatus 110 may monitor an electrical characteristic between the first electrode pattern 131 to which the reference voltage is applied and the second electrode pattern 132 corresponding to the first electrode pattern 131 (520).

The moisture detection apparatus 110 may generate a monitoring signal based on the monitored electrical characteristic (530). The moisture detection apparatus 110 may generate a monitoring signal based on a voltage value VMON measured by the second electrode pattern 132.

The moisture detection apparatus 110 may compare the monitoring signal with preset reference data (540). Here, the reference data includes at least one of a reference voltage level, a reference current level, and a reference matching resistance value for each moisture content, and the moisture detection apparatus 110 may compare the monitoring signal with the reference data. At this time, the reference data may be differently applied according to the type of pressurized medium 111.

The moisture detection apparatus 110 may identify moisture content of the pressurized medium 111 based on a comparison result (550).

The moisture detection apparatus 110 may output a warning signal when moisture content of the pressurized medium 111 exceeds a preset threshold value (560). At this time, the warning signal may be output through an output device of the vehicle 1 so that a driver can confirm.

According to the disclosed invention, an apparatus and method for detecting moisture that can accurately detect moisture content in brake oil may be provided. By monitoring moisture content contained in brake oil in real time, a warning can be provided to a driver in advance before moisture content reaches a dangerous level, thereby significantly improving vehicle safety.

In particular, by utilizing a principle of reacting to positive voltage using anionic characteristics of brake oil and water, more accurate moisture content measurement is possible. In addition, by applying a temperature correction algorithm, reliable measurement results can be obtained even under various environmental conditions.

A dual structure through a plurality of electrode patterns can further improve reliability of measurement. Even when one pair of electrode patterns is damaged or malfunctions, continuous measurement is possible through another pair, and measurement error can be detected through comparison of two measurement values.

In addition, the present invention is designed integrally with a reservoir cap, so installation is easy, and application is possible without major changes to existing brake systems. This can lead to productivity improvement and cost reduction effects.

From a driver's perspective, the state of brake oil can be checked in real time, so maintenance can be performed at an appropriate time. Through this, unnecessary replacement can be prevented and optimal replacement timing can be determined, thereby reducing maintenance costs.

Furthermore, the present invention is capable of interlocking with a vehicle telematics system, and expansion to a predictive maintenance system through big data analysis is possible. This can also be utilized as an important safety device in future mobility such as autonomous vehicles.

As a result, fatal brake failure such as vapor lock can be prevented through the present invention, which is an important effect directly related to driver safety. In addition, insurance cost reduction effect due to overall safety improvement of vehicles can also be expected.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An apparatus for detecting moisture, comprising:
a moisture detection module configured to output a signal based on moisture content of a pressurized medium stored in a reservoir; and
a controller configured to identify the moisture content of the pressurized medium based on an output signal of the moisture detection module,
wherein the moisture detection module comprises:
a substrate;
a plurality of electrode patterns provided on the substrate and configured to be submerged in the pressurized medium;
a connector provided on one side of the reservoir and connected to the controller; and
a signal line connecting the plurality of electrode patterns and the connector,
wherein the controller is configured to:
generate a monitoring signal based on an output signal of at least one of the plurality of electrode patterns;
compare the monitoring signal with preset reference data; and
identify the moisture content of the pressurized medium based on a comparison result.

2. The apparatus of claim 1, wherein the reference data comprises at least one of a reference voltage level, a reference current level, and a reference matching resistance value between the plurality of electrode patterns corresponding to the moisture content of the pressurized medium.

3. The apparatus of claim 1, wherein the controller comprises a memory storing a lookup table in which the reference data is recorded.

4. The apparatus of claim 1, wherein the plurality of electrode patterns comprise:
a first electrode pattern provided on at least one surface of the substrate and configured to receive a reference voltage; and
a second electrode pattern provided on the at least one surface of the substrate spaced apart from the first electrode pattern and configured to output a signal based on the moisture content of the pressurized medium.

5. The apparatus of claim 4, wherein the plurality of electrode patterns further comprise:
a third electrode pattern provided on another surface of the substrate and configured to receive the reference voltage; and
a fourth electrode pattern provided on the other surface of the substrate and configured to output a signal based on the moisture content of the pressurized medium.

6. The apparatus of claim 4, wherein the controller is configured to generate the monitoring signal based on a signal output from the second electrode pattern by a resistance formed between the first electrode pattern and the second electrode pattern.

7. The apparatus of claim 1, wherein the plurality of electrode patterns comprise:
a first electrode pattern provided on one surface of the substrate and configured to receive a reference voltage; and
a second electrode pattern provided on another surface of the substrate and configured to output a signal based on the moisture content of the pressurized medium.

8. The apparatus of claim 1, wherein the connector is integrally provided on a reservoir cap coupled to an upper end of the reservoir.

9. The apparatus of claim 8, wherein each of the plurality of electrode patterns extends linearly along one axial direction of the substrate, and
the substrate is vertically arranged based on connection of the connector and the signal line.

10. The apparatus of claim 9, wherein the moisture detection module is configured to output a signal based on a change in level of the pressurized medium.

11. The apparatus of claim 1, wherein the controller is configured to output a warning signal when the moisture content of the pressurized medium exceeds a preset threshold value.

12. A method for detecting moisture content of a pressurized medium by a moisture detection apparatus, the method comprising:
applying a reference voltage to at least one of a plurality of electrode patterns;
monitoring an electrical characteristic between an electrode pattern to which the reference voltage is applied and an electrode pattern corresponding to the electrode pattern to which the reference voltage is applied;
generating a monitoring signal based on the monitored electrical characteristic;
comparing the monitoring signal with preset reference data; and
identifying the moisture content of the pressurized medium based on a comparison result.

13. The method of claim 12, wherein the reference data comprises at least one of a reference voltage level, a reference current level, and a reference matching resistance value between the electrode patterns corresponding to the moisture content of the pressurized medium.

14. The method of claim 12, wherein the applying of the reference voltage comprises applying the reference voltage to a first electrode pattern disposed on at least one surface of a substrate among the plurality of electrode patterns.

15. The method of claim 14, wherein the generating of the monitoring signal comprises generating the monitoring signal based on a signal output from a second electrode pattern disposed spaced apart from the first electrode pattern.

16. The method of claim 15, wherein the first electrode pattern and the second electrode pattern are provided on one surface of the substrate or are respectively provided on different surfaces of the substrate.

17. The method of claim 12, wherein the plurality of electrode patterns extend linearly along one axial direction of a substrate, and
the substrate is vertically arranged based on connection with a connector integrally provided on a reservoir cap coupled to an upper end of a reservoir.

18. The method of claim 17, wherein the generating of the monitoring signal comprises additionally monitoring a signal based on a change in level of the pressurized medium.

19. The method of claim 12, further comprising:
outputting a warning signal when the moisture content of the pressurized medium exceeds a preset threshold value.

20. The method of claim 12, further comprising:
storing a change trend of the identified moisture content; and
predicting a replacement time of the pressurized medium based on the stored change trend.
